(19) United States
(12) Patent Application Publication
(10) Pub. No.: US 2014/0130922 A1
(43) Pub. Date: May 15, 2014

(54) Control Methods and Hardware Configurations for Ozone Delivery Systems

(71) Applicant: INTERMOLECULAR, INC., San Jose, CA (US)

(72) Inventors: ShouQian Shao, Fremont, CA (US); Vincent Li, Fremont, CA (US); Jason R. Wright, Saratoga, CA (US)

(73) Assignee: INTERMOLECULAR, INC., San Jose, CA (US)

(21) Appl. No.: 13/674,335

(22) Filed: Nov. 12, 2012

(51) Int. Cl. C01B 13/11; F16K 21/00

(52) U.S. Cl. CPC C01B 13/11; F16K 21/00
USPC 137/861; 422/111

(57) ABSTRACT

Systems and methods to delivery multiple ozone flows from a single ozone generator are disclosed. An ozone distribution manifold can include an oxygen input for converting the output from the ozone generator to multiple ozone flows with different ozone concentration. The ozone distribution manifold can include multiple flow controllers to regulate the multiple ozone flows to provide different ozone flow rates.

### FIELD OF THE INVENTION

The present invention relates generally to controlling ozone concentrations and flow rates, and particularly related to ozone generators and methods and apparatuses for distributing outputs from ozone generators.

### BACKGROUND OF THE INVENTION

Ozone has been widely used in semiconductor processing. For example, ozone can be used in combination with tetraethyl orthosilicate (TEOS) to deposit silicon dioxide. Ozone can be used in atomic layer deposition (ALD) process to form oxide films, such as aluminum oxide or hafnium oxide. Ozone can also be used for cleaning semiconductor wafers and semiconductor equipment, especially for removing hydrocarbon residues.

Among the methods for producing ozone, corona discharge method is the most common for ozone production. In the corona discharge method, oxygen is passed through the space between two electrodes. When a voltage is applied to the electrodes, a corona discharge is formed between the two electrodes, converting the oxygen in the discharge gap to ozone. In a typical corona discharge phenomenon, oxygen molecules O₂ are split into oxygen atoms O, which then combine with remaining oxygen molecules to form ozone, O₃.

FIGS. 1A-1B illustrate an exemplary ozone generator using corona discharge method. FIG. 1A shows a schematic representation of an ozone generator, comprising electrodes 112 and 114 disposed to form a space 116, which accepts an oxygen, or oxygen-containing, gas 118. When a voltage V is supplied to the electrodes, for example, by applying a positive voltage to electrode 112 and grounding the electrode 114, a corona discharge is formed, and the output flow 119 includes a mixture of oxygen and ozone.

FIG. 1B shows a block diagram of an exemplary ozone delivery system, comprising an ozone generator 130, which accepts an oxygen flow 122. The oxygen flow rate 122 is regulated by a flow controller 120. The ozone generator 130 can also accept a catalyst gas, such as nitrogen 127. The nitrogen 127 flow rate is regulated by a flow controller 125. An ozone monitor 140 is coupled to the output of the ozone generator to measure the amount of ozone generated, such as monitoring the concentration of ozone. In addition, a pressure regulator 150 can be included to regulate the pressure in the ozone generator 130 for optimizing the ozone generating condition. Exhaust conduit 158 or pressure relief path can be included. A system controller 160 can be included to control the ozone delivery system, such as setting the power of the ozone generator 130 to match the flow rates of oxygen and nitrogen according to the ozone amount measure by the ozone monitor, or setting the flow rates of oxygen, nitrogen and ozone concentration to have a auto control to match the required process condition.

In the ozone generator, an ozone output with specific ozone concentration and flow rate can be generated, for example, by controlling the input oxygen flow rate and the power of the ozone generator. Typically, an ozone delivery system can deliver a single ozone output, providing a desired ozone flow and concentration to a processing system. Multiple ozone outputs thus require multiple ozone generators. Thus the cost of ozone delivery systems can be significant for a fabrication facility utilizing multiple processing systems having ozone processes.

Therefore, ozone delivery systems capable of providing multiple ozone outputs are needed that overcome the shortcomings of current delivery systems.

### SUMMARY OF THE DESCRIPTION

In some embodiments, the present invention discloses methods and systems to distribute an output from an ozone generator to multiple process chambers. An ozone output with fixed concentration and flow rate can be converted to multiple ozone flows having different ozone concentrations and flow rates to be delivered to the multiple process chambers. The conversion process and assembly can allow one ozone generator to provide multiple ozone outputs, each with same or different ozone concentration and/or flow rate.

In some embodiments, the present invention discloses an ozone conversion assembly, which can accept an ozone input having an ozone concentration and flow rate and provide an ozone output having different ozone concentration and/or flow rate. For example, the ozone conversion assembly can include an oxygen input, allowing varying the ozone concentration from the input to the output. The ozone conversion assembly can also include a flow controller, allowing varying the flow rate from the input to the output.

In some embodiments, the present invention discloses an ozone distribution manifold, which includes multiple ozone conversion assemblies for supplying different ozone flows. The conversion assemblies can be optimized, for example, one assembly can omit the oxygen input, and thus maintain the same ozone concentration as provided by the ozone generator.

In some embodiments, the present invention discloses an ozone delivery system, which can generate multiple ozone flows with different concentrations and flow rates from an ozone generator. The ozone delivery system can include an ozone distribution manifold, allowing converting the output of the ozone generator to multiple ozone flows.

In some embodiments, the present invention discloses methods to convert and distribute an ozone input flow into multiple ozone output flows. One ozone output flow can maintain the same ozone concentration as the ozone input flow, and other ozone output flows can achieve the desired ozone concentration by diluting the ozone input flow with oxygen.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIGS. 1A-1B illustrate an exemplary ozone generator using corona discharge method.

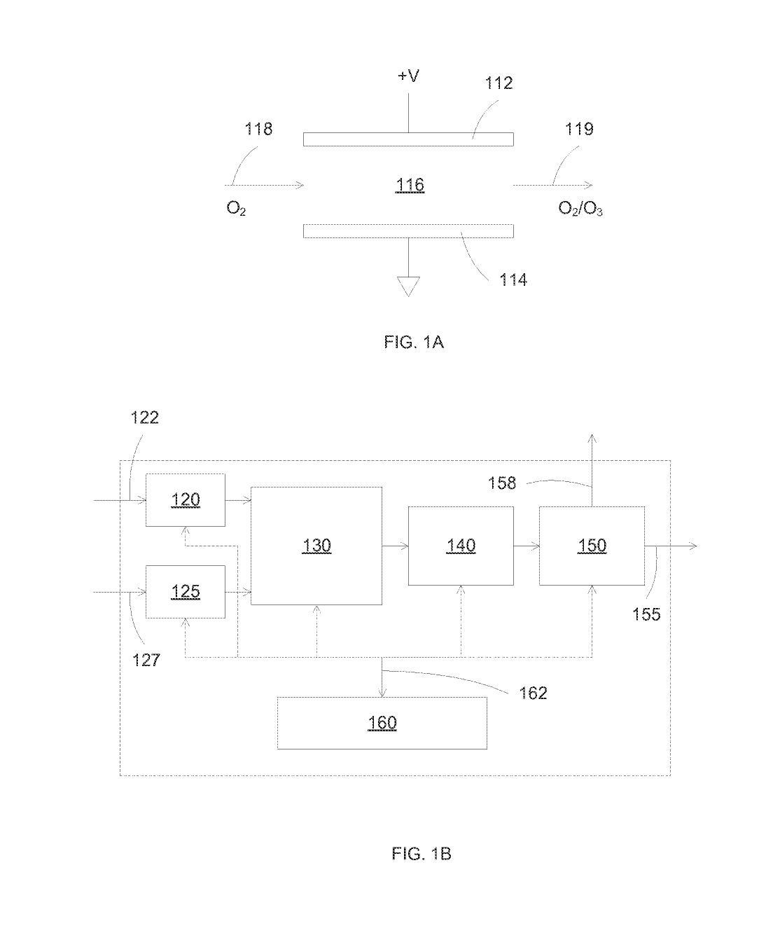

FIGS. 2A-2B illustrate ozone conversion assemblies according to some embodiments.

FIGS. 3A-3B illustrate flowcharts for generating ozone output flow according to some embodiments.

FIG. 4 illustrates a flowchart for generating ozone output flow according to some embodiments.

FIG. 5 illustrates another flowchart for generating ozone output flow according to some embodiments.

FIG. 6 illustrates a distribution manifold according to some embodiments.

FIGS. 7A-7B illustrate configurations for a distribution manifold according to some embodiments.

FIGS. 8A-8B illustrate other configurations for a distribution manifold according to some embodiments.

FIGS. 9A-9B illustrate flowcharts for generating multiple ozone output flows according to some embodiments.

FIG. 10 illustrates another flowchart for generating multiple ozone output flows according to some embodiments.

FIG. 11 illustrates a configuration utilizing an ozone generator for delivering two ozone outputs according to some embodiments.

FIG. 12 illustrates a flow chart for delivering multiple ozone flows to multiple chambers from an ozone generator.

FIG. 13 illustrates another configuration utilizing an ozone generator for delivering two ozone outputs according to some embodiments.

FIG. 14 illustrates another configuration utilizing an ozone generator for delivering two ozone outputs according to some embodiments.

### DETAILED DESCRIPTION OF THE PREFERRED EMBODIMENTS

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Ozone process is widely used in the semiconductor processing. In general, the ozone delivery system is expensive and can be a large part in the total tool cost. In some embodiments, novel control methods and hardware configurations to significantly reduce the cost for using ozone, especially for large scale manufacturing are provided. For example, systems and methods to deliver multiple ozone flows at different ozone flow rates and concentrations, all generated from a single ozone generator are disclosed. As such, a single ozone generator can provide a first ozone flow at high concentration and a second ozone flow at lower concentration.

In some embodiments, methods and systems to distribute an output from an ozone generator to multiple process chambers are disclosed. An ozone output with a fixed concentration and flow rate can be converted to multiple ozone flows having different ozone concentrations and flow rates to be delivered to the multiple process chambers. The conversion process and assembly can allow one ozone generator to provide multiple ozone outputs, each with same or different ozone concentration and/or flow rate.

Conventionally, the flow rates of ozone and oxygen are expressed as mass flow rate, e.g., having unit of mass over time. The concentration of ozone is expressed as weight percent (wt %), representing the weight of the ozone component in the mixture of ozone and oxygen flow. Thus an ozone flow having ozone concentration C and flow rate F can include a component flow of ozone F₁ and a component flow of oxygen F₂. The ozone amount in the ozone flow is thus CF.

In some embodiments, an ozone conversion assembly, which can accept an ozone input having an ozone concentration and flow rate and provide an ozone output having different ozone concentration and/or flow rate is disclosed. For example, to reduce the concentration, the ozone output can be mixed with an oxygen flow. To reduce the flow rate, a flow controller can be used, restricting the ozone output flow to the desired flow rate. An ozone flow controller can be used, in which the setting can be the desired ozone flow rate. An oxygen flow controller can be used, in which the setting can be adjusted based on the characteristics of ozone versus those of oxygen, together with the concentration of the ozone flow.

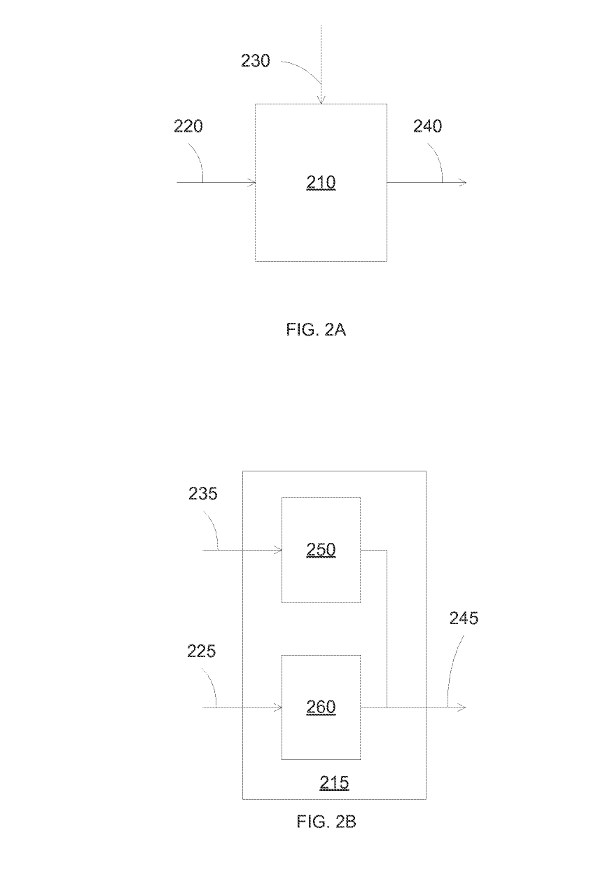

FIGS. 2A-2B illustrate ozone conversion assemblies according to some embodiments. In FIG. 2A, an ozone input flow 220 can be provided to an ozone conversion assembly 210, together with an oxygen input flow 230. An ozone output flow rate 240 can be provided, with same or different flow rate and concentration from the ozone input flow 220.

Let c1 and f1 be the concentration and flow rate of the ozone input flow 220, respectively, c2 and f2 be the concentration and flow rate of the ozone output flow 240, respectively, and f3 be the flow rate of the oxygen flow 230. The ozone output flow rate is the sum of the input flow rates of input ozone and oxygen:

f2=f1+f3 (1)

The amount of ozone in the ozone input flow is the same as in the ozone output flow:

c1f1=c2f2 (2)

Thus, given an ozone input flow having flow rate f1 and concentration c1, together with an oxygen flow rate f3, the ozone output flow rate f2 is the sum of the two input flows and the concentration c2 can be

$$c 2 = c 1 \frac{f 1}{f 2} \qquad ( 3 )$$

Alternatively, to achieve an ozone output concentration of c2 given an ozone input flow rate of f1 and concentration c1, the oxygen flow rate can be set as followed:

$$f 3 = f 1 ( \frac{c 1 - c 2}{c 2} ) \qquad ( 4 )$$

FIG. 2B shows another ozone converter assembly 215 according to some embodiments. Flow controllers 250 and 260 can be used to regulate the flow rates of the inputs, e.g., flow controller 250 regulating an oxygen input flow 235 and flow controller 260 regulating an ozone input flow 225. The relationship between the inputs and output can be expressed as in equations 1 and 2 above, except that the flow rates f1 and f3 are measured at the outputs of the flow controllers 250 and 260, respectively.

The ozone flow rate f1, for the flow controller 260, can be set as followed:

$$f 1 = f 2 \frac{c 2}{c 1} \qquad ( 5 )$$

The oxygen flow rate f3, for the flow controller 250, can be set as followed:

$$f 3 = f 2 - f 1 = f 2 ( \frac{c 1 - c 2}{c 1} ) \qquad ( 6 )$$

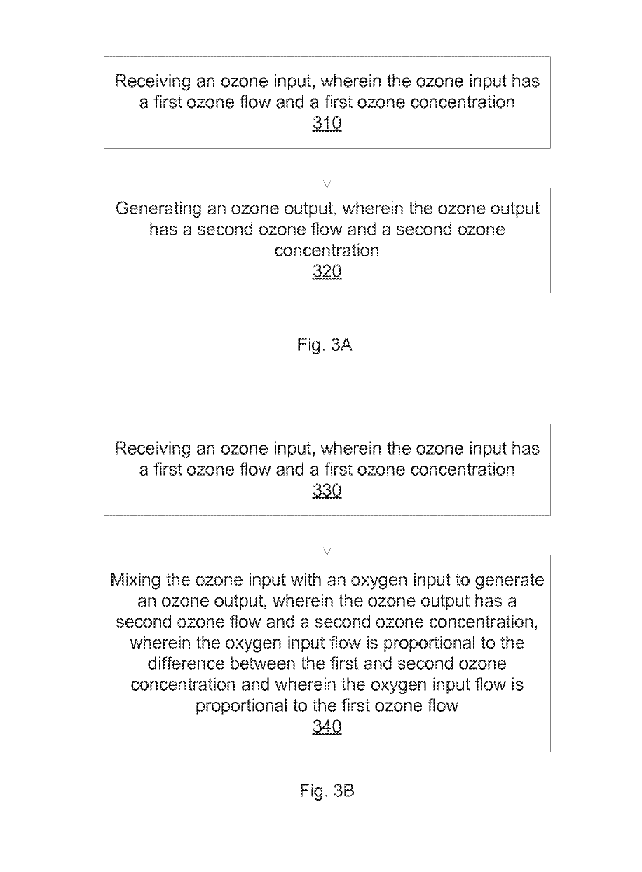

FIGS. 3A-3B illustrate flowcharts for generating ozone output flow according to some embodiments. In FIG. 3A, operation 310 receives an ozone input having a first ozone flow rate and a first ozone concentration. Operation 320 generates an ozone output from the ozone input, wherein the ozone output has a second ozone flow rate and a second ozone concentration. The output ozone flow rate can be similar or can be different from the input ozone flow rate. The output ozone concentration can be similar or can be different from the input ozone concentration.

In some embodiments, the output ozone concentration can be regulated and achieved by setting a dilution flow of oxygen. In FIG. 3B, operation 330 receives an ozone input having a first ozone flow rate and a first ozone concentration. Operation 340 mixes the ozone input with an oxygen input to generate an ozone output. The ozone output has a second ozone flow rate and a second ozone concentration. With the oxygen input mixing with the ozone input, the second ozone concentration is less than the first ozone concentration, and can be set at a desired value by specifying the oxygen input. For example, to achieve a specific second ozone concentration, the oxygen input flow rate can be set to be proportional to the difference between the first and second ozone concentration, and also to the first ozone flow rate. Equation 6 above shows an example of a formula for the oxygen input flow rate.

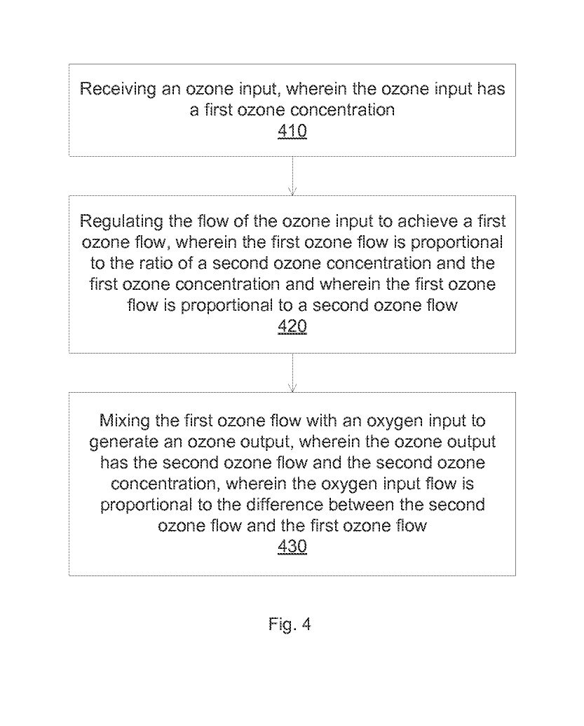

In some embodiments, both output ozone concentration and flow rate can be regulated. FIG. 4 illustrates a flowchart for generating ozone output flow according to some embodiments. Operation 410 receives an ozone input having a first ozone concentration. Operation 420 regulates the flow rate of the ozone input to achieve a first ozone flow rate. The ozone input is regulated based on the requirements, e.g., ozone flow rate and concentration, of the ozone output. For example, the first ozone flow rate can be set per Equation 5, which is proportional to the ratio of a second (e.g., desired) ozone concentration and the first (e.g., input) ozone concentration and also proportional to the second (e.g., desired) ozone flow rate. Operation 430 mixes the first ozone flow with an oxygen input to achieve a second, e.g., output ozone flow. For example, the oxygen input flow rate can be set per Equation 6, which is proportional to the difference between the first and second ozone concentration, and to the second (e.g., desired) ozone flow rate.

In some embodiments, the flow controller 260 can be an ozone mass flow controller, and thus can provide an ozone flow rate of f1 when set at the value of f1. An ozone mass flow controller can be found in U.S. patent application Ser. No. 13/271,471, entitled “Systems and Methods for Measuring, Monitoring, and Controlling Ozone Concentration” filed on Oct. 12, 2011, and in U.S. patent application Ser. No. 13/271,449, entitled “Systems and Methods for Measuring, Monitoring, and Controlling Ozone Concentration” filed on Oct. 12, 2011, and which are each herein incorporated in reference.

In some embodiments, the flow controller 260 can be an oxygen mass flow controller. The flow rate of the oxygen mass flow controller can be set at F_{eq} in order to provide an ozone flow rate of f1. For a mixture flow having ozone flow F₁ with specific heat Cₚ₁ and oxygen flow F₂ with specific heat Cₚ₂, a measured heat flux q for the mixture flow can be, with k being a proportional constant:

q=kF₁Cₚ₁+k F₂Cₚ₂=k(F₁Cₚ₁+F₂Cₚ₂) (7)

If using an oxygen mass flow controller, the heat flux corresponds to an oxygen flow rate of F_{eq}

q=kF_{eq}Cₚ₂ (8)

Thus setting the oxygen mass flow controller at the value F_{eq} can provide an ozone flow having flow rate F=F₁+F₂ and concentration C of

$$C = \frac{{F}_{1}}{{F}_{1} + {F}_{2}}$$

$$Feq = FC \frac{{C}_{p 1}}{{C}_{p 2}} + ( F - FC ) \qquad ( 9 )$$

Other mass flow controllers can be used, such as nitrogen-calibrated mass flow controller, using appropriate conversion factors.

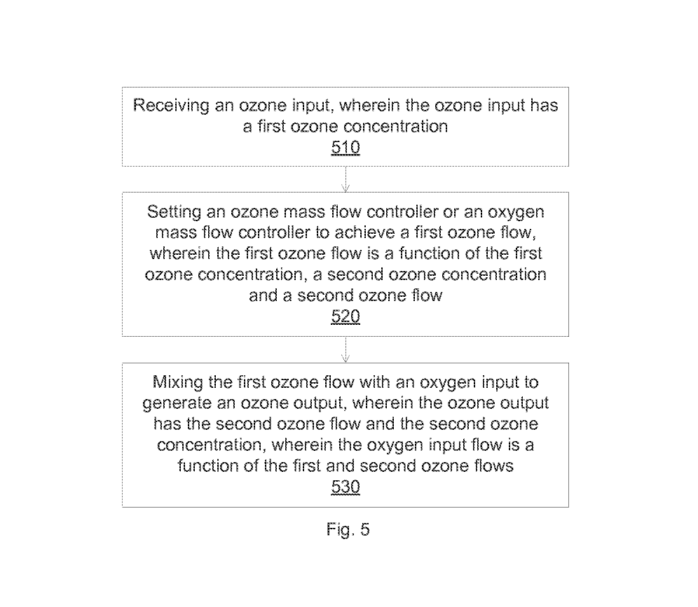

FIG. 5 illustrates another flowchart for generating ozone output flow according to some embodiments. Operation 510 receives an ozone input having a first ozone concentration. Operation 520 sets an ozone mass flow controller or an oxygen mass flow controller to achieve a first ozone flow. Operation 530 mixes the first ozone flow with an oxygen input to achieve a second, e.g., output ozone flow.

In some embodiments, an ozone distribution manifold that can accept an ozone input and provide multiple ozone outputs is disclosed. The ozone outputs can have the same or different ozone flow rates and/or concentrations than the ozone input. In some embodiments, the ozone distribution manifold can include multiple ozone conversion assemblies for supplying different ozone flows. The conversion assemblies can have first mass flow controllers for regulating the ozone flow rates and second mass flow controllers for regulating oxygen flow rates. The distribution manifold can be optimized, for example, one assembly in the distribution manifold can omit the oxygen mass flow controller, and thus can provide the same ozone concentration as provided by the ozone generator.

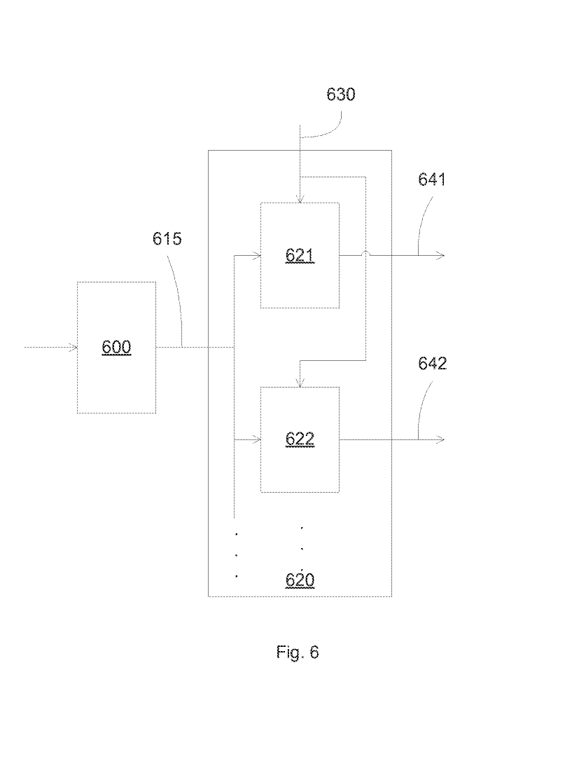

FIG. 6 illustrates a distribution manifold according to some embodiments. An ozone generator 600 can deliver an ozone output 615, which can be used as input for an ozone distribution manifold 620. Oxygen input 630 can also be provided to the manifold 620. The manifold 620 can include multiple conversion assemblies 621, 622, . . . , which can accept the ozone input 615 and the oxygen input 630 to provide multiple ozone outputs 641, 642, . . . , respectively.

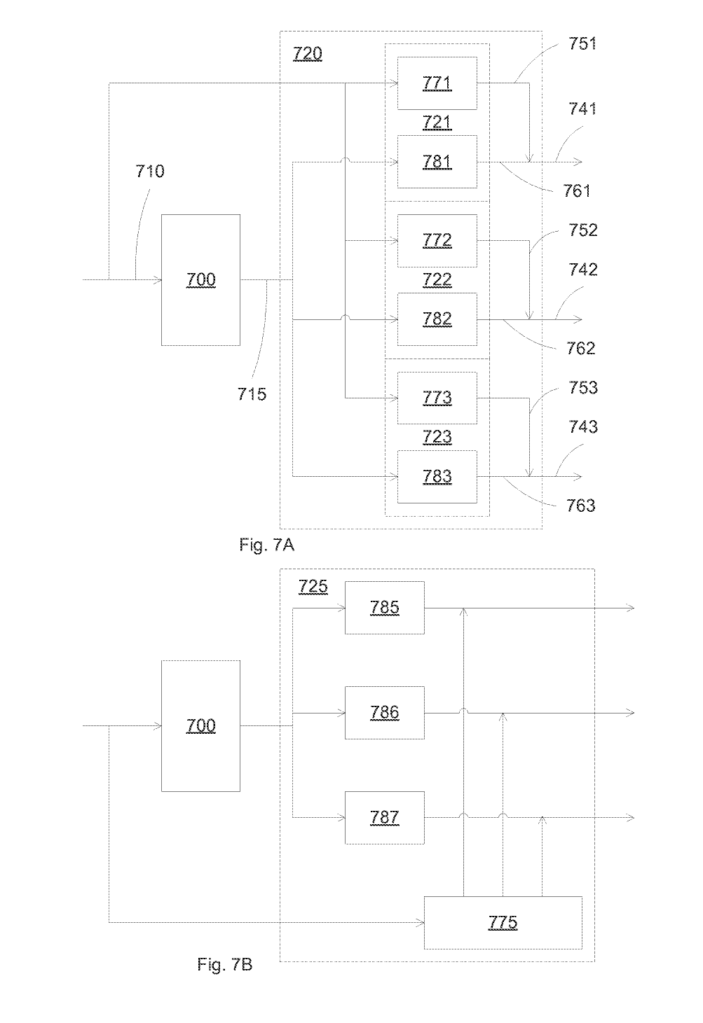

FIGS. 7A-7B illustrate configurations for a distribution manifold according to some embodiments. In FIG. 7A, a distribution manifold 720 includes multiple conversion assemblies 721, 722, and 723. Each conversion assembly 721, 722, and 723 can include a first mass flow controller 781, 782, and 783, to regulate the ozone flow rates 761, 762, and 763, and a second mass flow controller 771, 772, and 773, respectively, to regulate the oxygen flow rate 751, 752, and 753, respectively. The regulated ozone flow rates 761, 762, and 763, and the regulated oxygen flow rates 751, 752, and 753 are mixed to form the ozone output flows 741, 742, and 743, respectively. The distribution manifold 720 can accept an ozone flow input 715, which can be the output of an ozone generator 700. The distribution manifold 720 can accept an oxygen flow input 710, which can also be the input to the ozone generator 700. Additional gases can be provided to the ozone generator 700, for example, nitrogen gas.

FIG. 7B shows another configuration for a distribution manifold 725. Multiple mass flow controllers 785, 786, and 787 can be used to regulate the ozone flow rates. Multiple oxygen flow rates can be provided by an oxygen manifold 775, to be mixed with the ozone flow rates.

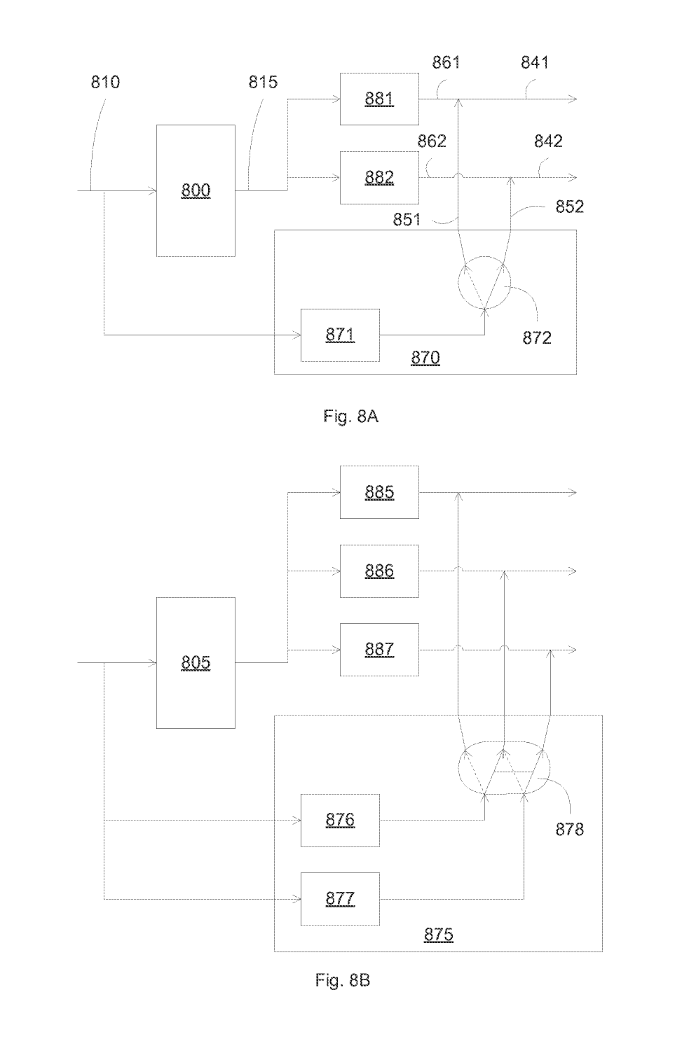

FIGS. 8A-8B illustrate other configurations for a distribution manifold according to some embodiments. Mass flow controllers can be used to regulate the ozone flows, and an oxygen manifold can be used to distribute oxygen to the ozone flows to form output ozone flows having appropriate ozone concentration.

FIG. 8A shows an ozone generator 800 coupled to a distribution manifold to provide two ozone flows 841 and 842, which can have similar or different ozone flow rates and/or concentrations. The ozone flow rates 861 and 862 can be regulated by mass flow controllers 881 and 882, respectively. An oxygen distribution 870 can be used to provide oxygen to the ozone flows, for example, to change the concentration of the output ozone flows. The oxygen distribution 870 can include a two-way switch 872, which can deliver oxygen to either the ozone flow 861 or 862, providing output ozone flows 841 and 842 with appropriate concentration and flow rates. A mass flow controller 871 can be included to regulate the flow rate of the oxygen flow 851 or 852.

In some embodiments, the ozone generator 800 can be configured to deliver the higher ozone concentration between the two ozone concentrations to be delivered in ozone flows 841 and 842. Therefore, the flow that has the higher ozone concentration can be coupled directly from the ozone generator without any oxygen input flow. Thus the oxygen input flow can be provided to the ozone flow having the lower ozone concentration, for example, through the switch 872.

For example, assuming that the requirements for ozone flows 841 and 842 include an ozone concentration of A wt % and B wt %, respectively, and an ozone flow rates of a slm and b slm, respectively. Further, assuming that A is greater or equal to B. The ozone generator 800 can be set to provide an ozone concentration of A wt %, and switch 872 is set to be connected to ozone flow 862 to provide oxygen to this flow to dilute the A wt % concentration to B wt % concentration. The mass flow controller 881 can be set to deliver ozone flow rate of a slm. Thus ozone output 815 from the ozone generator 800 is regulated directly to provide ozone flow 841 having ozone concentration A wt % and a slm.

To achieve ozone flow 842 having ozone concentration B wt % and b slm, provided from the ozone flow 815 having ozone concentration A wt %, the mass flow controllers 882 and 871 can be set per equations 5 and 6 above. In other words, the mass flow controller 882 is regulated to provide an ozone flow rate that when mixed with the oxygen flow rate from mass flow controller 871, an ozone output 842 can be provided.

The flow rate of the ozone generator output 815 can be the sum of the flow rates through the mass flow controllers 881 and 882. To achieve the output flow rate, an oxygen flow rate of the ozone generator input 810 can be set appropriately.

FIG. 8B shows an ozone generator 805 coupled to a distribution manifold to provide three ozone flows, which can have similar or different ozone flow rates and/or concentrations. Three mass flow controllers 885, 886, and 887 can be provided to regulate the ozone flow rates to the outputs. Two mass flow controllers 876 and 877 can be provided, in an oxygen manifold 875, to distribute the oxygen flows to either two of the three outputs. A switch 878 can be used for oxygen distribution.

Other numbers of ozone outputs can be used. In general, the oxygen manifold can have one less mass flow controllers, since one ozone output can be directly coupled to the ozone generator, thus can eliminate the use of an oxygen mass flow controller.

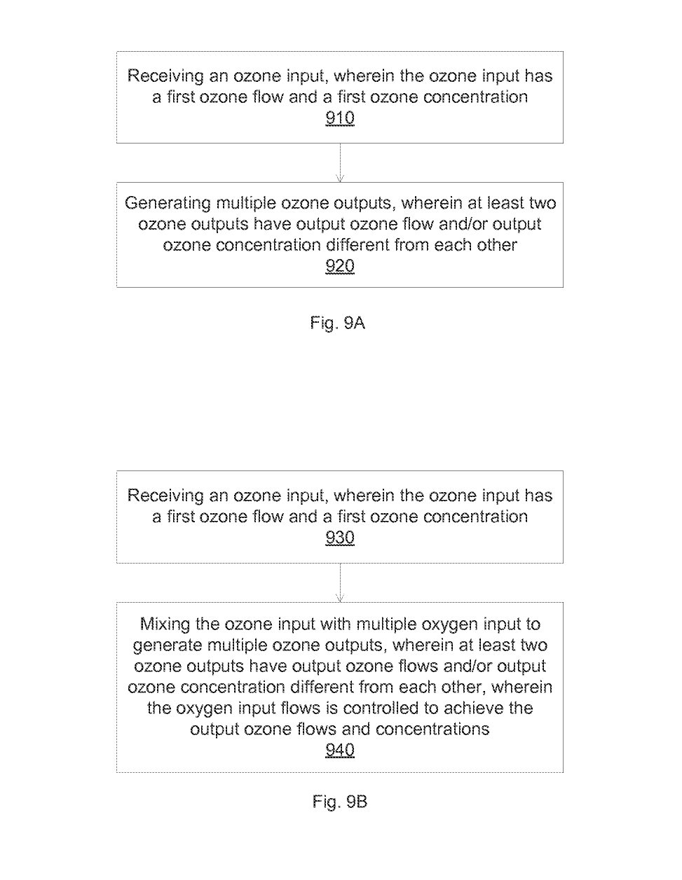

FIGS. 9A-9B illustrate flowcharts for generating multiple ozone output flows according to some embodiments. In FIG. 9A, operation 910 receives an ozone input having a first ozone flow and a first ozone concentration. Operation 920 generates multiple ozone outputs from the ozone input. The multiple ozone outputs can have concentration or flow rate similar or different from each other.

In some embodiments, the ozone input can be generated from an ozone generator. The ozone generator can be regulated to provide the ozone input (which is the output of the ozone generator) suitable for generating the multiple ozone outputs. For example, the ozone generator can be regulated to provide the highest ozone concentration within the multiple ozone outputs. Other ozone outputs can be mixed with oxygen inputs to achieve the desired concentrations. The ozone generator can be further regulated to provide the ozone input having appropriate amount of ozone to be distributed to the multiple ozone outputs. For example, to provide two ozone outputs having concentrations of A wt %, a slm and B wt %, b slm, the power of the ozone generator can be configured to generate A wt % concentration (assuming that A>B). The total amount of ozone in the two ozone outputs is thus aA+bB. The flow rate F of the ozone generator can be configured to provide this amount of ozone, e.g.,

FA=aA+bB (10)

In some embodiments, the output ozone concentration can be regulated and achieved by setting a dilution flow of oxygen. In FIG. 9B, operation 930 receives an ozone input having a first ozone flow rate and a first ozone concentration. Operation 940 mixes the ozone input with multiple oxygen inputs to generate multiple ozone outputs. The multiple ozone outputs can have concentration or flow rate similar or different from each other. The multiple oxygen inputs can be controlled to achieve the output ozone flow rates and concentrations.

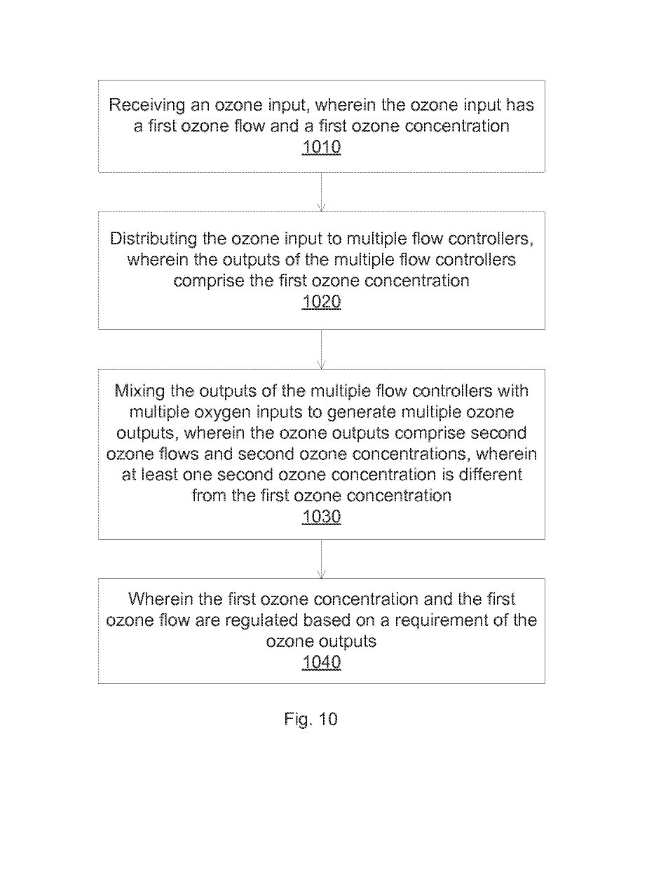

FIG. 10 illustrates another flowchart for generating multiple ozone output flows according to some embodiments. Operation 1010 receives an ozone input having a first ozone flow rate and a first ozone concentration. The ozone input can be provided from an ozone generator, wherein the power and oxygen input flow rate of the ozone generator can be regulated to achieve the desired ozone outputs. Operation 1020 distributes the ozone input to multiple flow controllers, wherein the outputs of the multiple flow controllers have the first ozone concentration. In other words, the flow controllers control the flow rate and not the concentration. Operation 1030 mixes the outputs from the multiple flow controllers with multiple oxygen inputs to generate multiple ozone outputs. The multiple ozone outputs can have concentration or flow rate similar or different from each other. Operation 1040 regulates the first ozone concentration, the first ozone flow, and the multiple oxygen inputs to achieve the output ozone flow rates and concentrations.

In some embodiments, an ozone delivery system, which can generate multiple ozone flows with different concentrations and flow rates from an ozone generator is disclosed. The ozone delivery system can include an ozone distribution manifold coupled to an ozone generator, allowing converting the output of the ozone generator to multiple ozone flows.

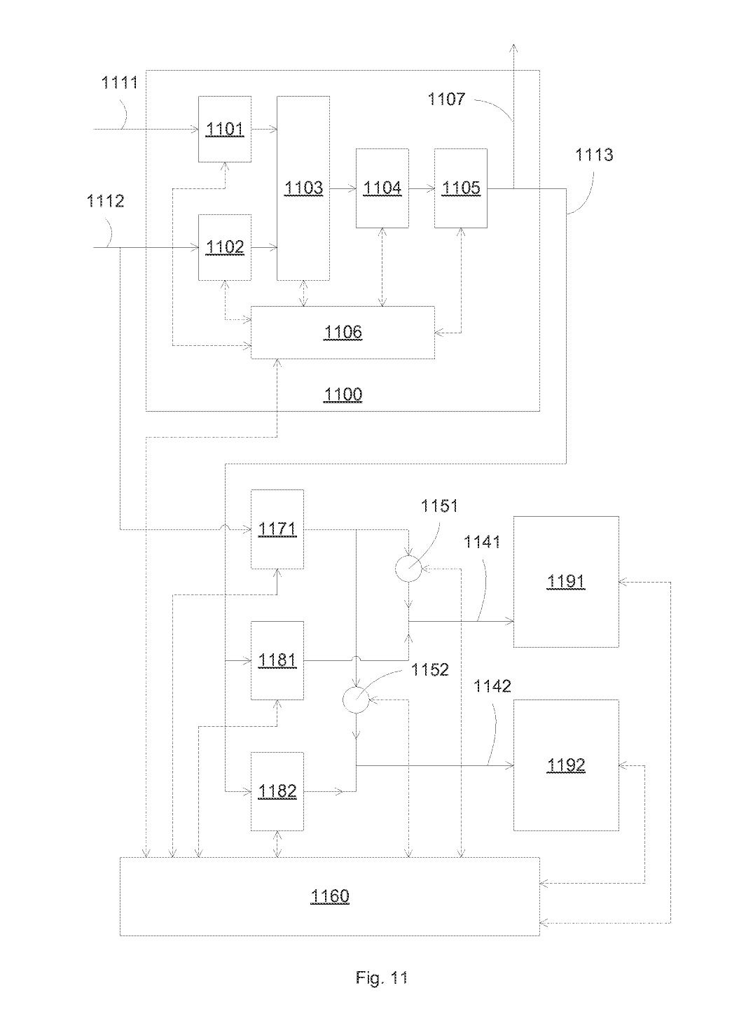

FIG. 11 illustrates a configuration utilizing an ozone generator for delivering two ozone outputs according to some embodiments. A single ozone generator 1100, which can be a conventional ozone generator, can be coupled to a distribution system to provide ozone outputs to process chamber 1191 and 1192. The configuration shows an ozone generator delivering two ozone outputs to two process chambers, but other number of ozone outputs and process chambers can be used, for example, more than two process chambers.

The ozone generator 1100 can include an oxygen input 1112, which can be regulated by a mass flow controller 1102. An ozone generation assembly 1103 can generate an ozone output, e.g., a mixture of oxygen and ozone, from the oxygen input. An ozone monitor 1104 can be used to monitor the ozone output. A pressure regulator 1105 can be included to regulate the pressure of the ozone output. For example, the ozone regulator 1105 can release excess ozone flow to an exhaust 1107 to prevent pressure built up. Other gases can be provided to the ozone generator 1100, for example, nitrogen gas 1111, which can be regulated by a mass flow controller 1101.

The ozone generator 1100 can include a system controller 1106, which can control the components within the ozone generator to generate an appropriate ozone output 1113. For example, the controller 1106 can regulate the power of the ozone generation assembly 1103 to achieve a proper ozone output concentration. The controller can also regulate the mass flow controller 1102 to allow adequate oxygen input flow to achieve a proper ozone output flow rate. The controller can also regulate other gas inputs, such as nitrogen input 1111 through the mass flow controller 1101, regulating the pressure regulator 1105, and monitoring the ozone output through the ozone monitor 1104.

The ozone generator 1100 can also accept external input signals, for example, from a tool controller 1160. For example, a tool controller 1160 can determine the maximum ozone concentration requirement and the total ozone flow requirement for the multiple process chambers. The tool controller 1160 than can provide the requirements to the ozone system controller 1106, which then can regulate the power and the oxygen input to achieve the required output ozone flow.

Flow controllers 1181 and 1182 can be used to regulate the ozone output 1113 from the ozone generator 1100. Flow controller 1171 can be used to regulate the oxygen input, for example from the oxygen input 1112, to be mixed with the regulated ozone outputs from flow controllers 1181 and 1182. Valves 1151 and 1152 can be used to select the regulated ozone output that the oxygen will be provided. For example, if valve 1151 is open, output 1141 will include a mixture of the ozone flow from flow controller 1181 and the oxygen flow from flow controller 1171. Alternatively, if valve 1152 is open, output 1142 will include a mixture of the ozone flow from flow controller 1182 and the oxygen flow from flow controller 1171. The valves 1151 and 1152 can be mutually exclusive, so that the oxygen flow can only be added to one ozone output from the flow controller s 1181 and 1182. The valves 1151 and 1152 can be toggled, for example, by the controller, so that one valve is on and the other valve is off.

Tool controller 1160 can communicate with the process chambers 1191 and 1192, for example, to receive the requirements of ozone flows to be delivered to the process chambers, and to report conditions of the ozone delivery system. The controller 1160 can control the valves 1151 and 1152 to obtain mixing of oxygen to the ozone outputs. The controller 1160 can control the flow controllers 1181, 1182 and 1171 to regulate the ozone and oxygen flows.

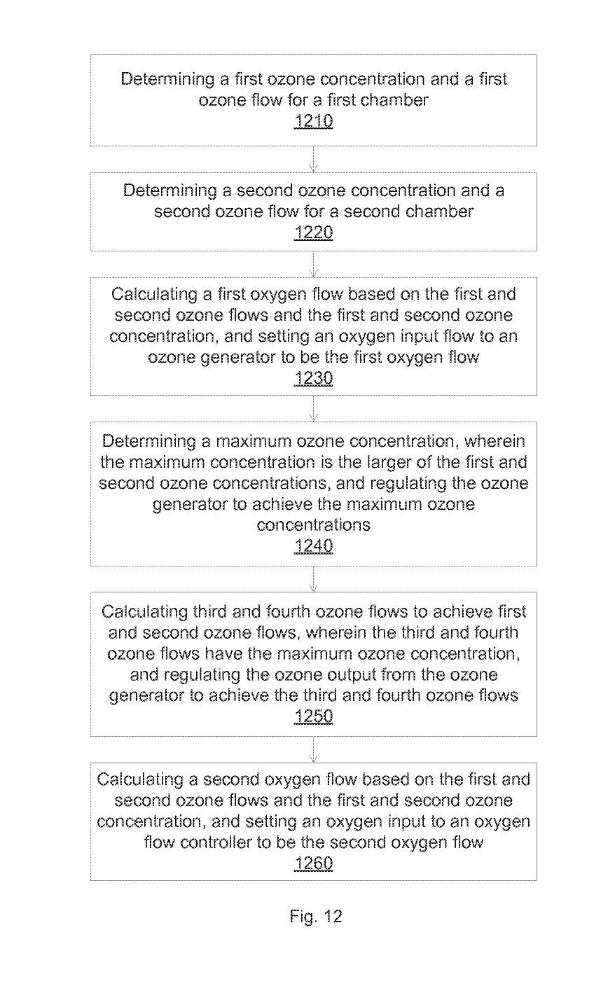

FIG. 12 illustrates a flow chart for delivering multiple ozone flows to multiple chambers from an ozone generator. In operation 1210, a first ozone concentration and a first ozone flow rate is determined for a first chamber. In operation 1220, a second ozone concentration and a second ozone flow rate is determined for a second chamber. For example, the ozone concentration and flow rate can be provided by the process requirements in a process chamber. In operation 1230, a first oxygen flow rate is calculated and a flow controller is regulated to achieve the first oxygen flow rate, which serves as an oxygen input to an ozone generator. The first oxygen flow rate can be calculated based on the first and second ozone flow rates and concentrations, for example, based on equation 10. In operation 1240, a maximum ozone concentration is determined from the first and second ozone concentration. The ozone generator can be regulated to generate an ozone output having the maximum ozone concentration. The ozone generator is configured to accept the first oxygen flow rate and to generate the maximum ozone concentration. The ozone output of the ozone generator, which is a mixture of oxygen and ozone components, will have equal or slightly larger ozone component to meet the ozone requirements of first and second chamber, e.g., per equation 10.

In operation 1250, third and fourth ozone flow rates are calculated, and the ozone output from the ozone generator is regulated to achieve the third and fourth ozone flow rates. For example, if the first ozone concentration is larger than the second ozone concentration, the third ozone flow rate can be the first ozone flow rate. The fourth ozone flow rate can be calculated from equation 5, which includes similar ozone component as the second ozone flow rate.

In operation 1260, a second oxygen flow rate is calculated and a flow controller is regulated to achieve the second oxygen flow rate, which serves as an oxygen input to mix with the third or fourth ozone flow rate. For example, if the first ozone concentration is larger than the second ozone concentration, the second oxygen flow rate is mixed with the fourth ozone flow rate to achieve the second ozone flow rate, which is to be delivered to the second chamber.

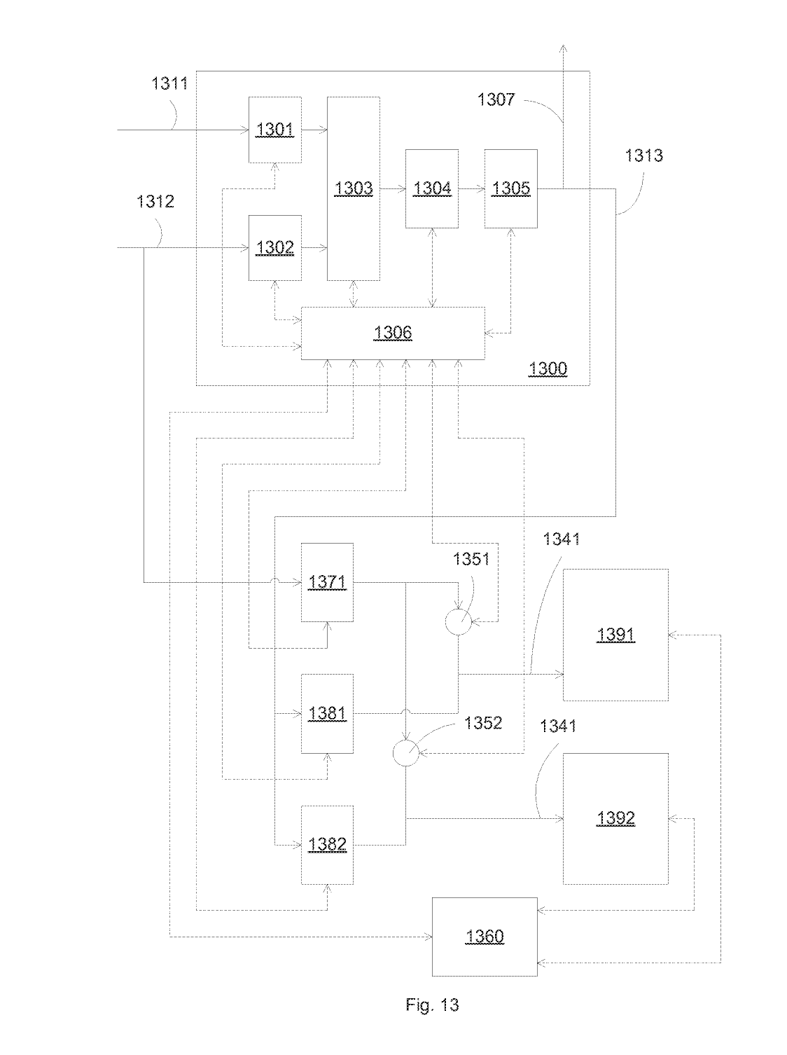

FIG. 13 illustrates another configuration utilizing an ozone generator for delivering two ozone outputs according to some embodiments. An ozone generator 1300 can be coupled to a distribution system to provide ozone outputs to process chamber 1391 and 1392. The configuration shows an ozone generator delivering two ozone outputs to two process chambers, but other number of ozone outputs and process chambers can be used, for example, more than two process chambers.

The ozone generator 1300 can include an oxygen input 1312, which can be regulated by a mass flow controller 1302. An ozone generation assembly 1303 can generate an ozone output, e.g., a mixture of oxygen and ozone, from the oxygen input. An ozone monitor 1304 can be used to monitor the ozone output. A pressure regulator 1305 can be included to regulate the pressure of the ozone output. For example, the ozone regulator 1305 can release excess ozone flow to an exhaust 1307 to prevent pressure built up. Other gases can be provided to the ozone generator 1300, for example, nitrogen gas 1311, which can be regulated by a mass flow controller 1301.

The ozone generator 1300 can include a system controller 1306, which can control the components within the ozone generator to generate an appropriate ozone output 1313. For example, the controller 1306 can regulate the power of the ozone generation assembly 1303 to achieve a proper ozone output concentration. The controller can also regulate the mass flow controller 1302 to allow adequate oxygen input flow to achieve a proper ozone output flow rate. The controller can also regulate other gas inputs, such as nitrogen input 1311 through the mass flow controller 1301, regulating the pressure regulator 1305, and monitoring the ozone output through the ozone monitor 1304.

The ozone generator 1300 can also accept external input signals, for example, from a tool controller 1360 and from other components of the ozone delivery system. For example, a tool controller 1360 can communicate with the process chambers 1391 and 1392, for example, to receive the requirements of ozone flows to be delivered to the process chambers, and to report conditions of the ozone delivery system. The tool controller 1360 than can provide the requirements to the ozone system controller 1306, which then can regulate the power and the oxygen input to achieve the required output ozone flow.

Flow controllers 1381 and 1382 can be used to regulate the ozone output 1313 from the ozone generator 1300. Flow controller 1371 can be used to regulate the oxygen input, for example from the oxygen input 1312, to be mixed with the regulated ozone outputs from flow controllers 1381 and 1382. Valves 1351 and 1352 can be used to select the regulated ozone output that the oxygen will be provided. For example, if valve 1351 is open, output 1341 will include a mixture of the ozone flow from flow controller 1381 and the oxygen flow from flow controller 1371. Alternatively, if valve 1352 is open, output 1342 will include a mixture of the ozone flow from flow controller 1382 and the oxygen flow from flow controller 1371. The valves 1351 and 1352 can be mutually exclusive, toggled between open and close so that one valve is open while the other valve is close, so that the oxygen flow can only be added to one ozone output from the flow controllers 1381 and 1382.

The ozone controller 1306 can also control the valves 1351 and 1352 to obtain mixing of oxygen to the ozone outputs. The controller 1306 can control the flow controllers 1381, 1382 and 1371 to regulate the ozone and oxygen flows.

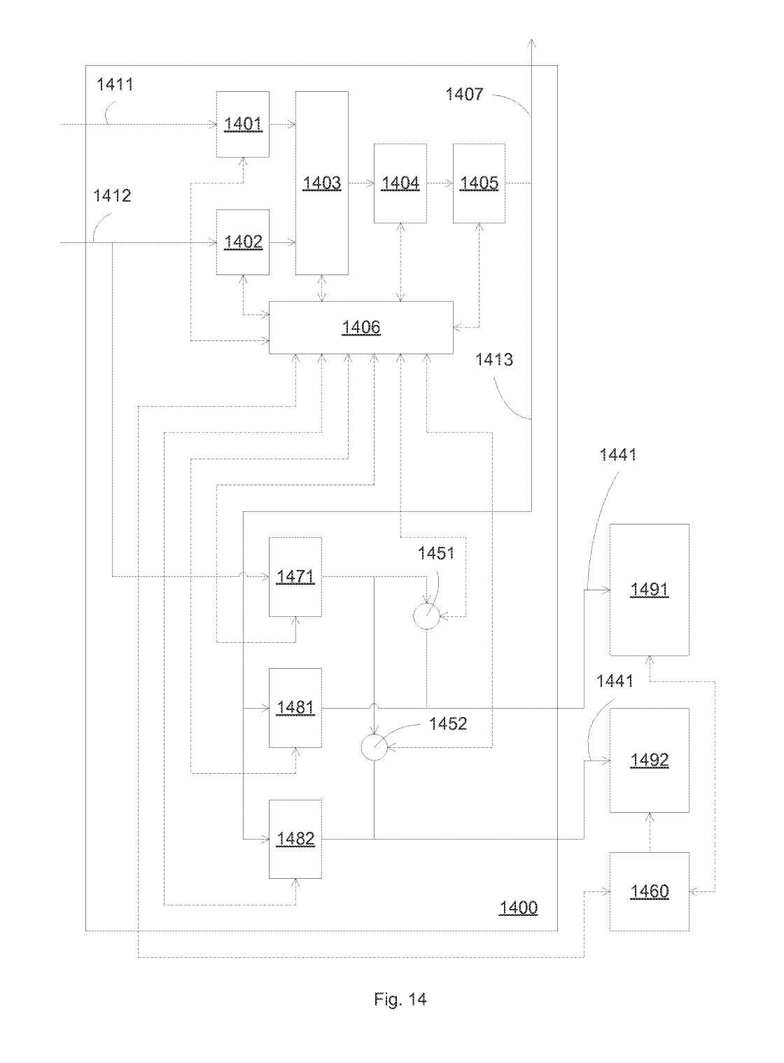

FIG. 14 illustrates another configuration utilizing an ozone generator for delivering two ozone outputs according to some embodiments. An ozone generator 1400 can be coupled to a distribution system to provide ozone outputs to process chamber 1491 and 1492. The configuration shows an ozone generator delivering two ozone outputs to two process chambers, but other number of ozone outputs and process chambers can be used, for example, more than two process chambers.

The ozone generator 1400 can include an oxygen input 1412, which can be regulated by a mass flow controller 1402. An ozone generation assembly 1403 can generate an ozone output, e.g., a mixture of oxygen and ozone, from the oxygen input. An ozone monitor 1404 can be used to monitor the ozone output. A pressure regulator 1405 can be included to regulate the pressure of the ozone output. For example, the ozone regulator 1405 can release excess ozone flow to an exhaust 1407 to prevent pressure built up. Other gases can be provided to the ozone generator 1400, for example, nitrogen gas 1411, which can be regulated by a mass flow controller 1401.

The ozone generator 1400 can include flow controllers 1481 and 1482 to regulate the ozone output 1413. The ozone generator 1400 can include flow controller 1471 to regulate the oxygen input, for example from the oxygen input 1412, to be mixed with the regulated ozone outputs from flow controllers 1481 and 1482. Valves 1451 and 1452 can be used to select the regulated ozone output that the oxygen will be provided. For example, if valve 1451 is open, output 1441 will include a mixture of the ozone flow from flow controller 1481 and the oxygen flow from flow controller 1471. Alternatively, if valve 1452 is open, output 1442 will include a mixture of the ozone flow from flow controller 1482 and the oxygen flow from flow controller 1471. The valves 1451 and 1452 can be mutually exclusive, e.g., toggled by a controller controlling the valves, so that the oxygen flow can only be added to one ozone output from the flow controllers 1481 and 1482.

The ozone generator 1400 can include a system controller 1406, which can control the components within the ozone generator to generate an appropriate ozone output 1413. For example, the controller 1406 can regulate the power of the ozone generation assembly 1403 to achieve a proper ozone output concentration. The controller can also regulate the mass flow controller 1402 to allow adequate oxygen input flow to achieve a proper ozone output flow rate. The controller can also regulate other gas inputs, such as nitrogen input 1411 through the mass flow controller 1401, regulating the pressure regulator 1405, and monitoring the ozone output through the ozone monitor 1404. The ozone controller 1406 can also control the valves 1451 and 1452 to obtain mixing of oxygen to the ozone outputs. The controller 1406 can control the flow controllers 1481, 1482 and 1471 to regulate the ozone and oxygen flows.

The ozone generator 1400 can also accept external input signals, for example, from a tool controller 1460. For example, a tool controller 1460 can communicate with the process chambers 1491 and 1492, for example, to receive the requirements of ozone flows to be delivered to the process chambers, and to report conditions of the ozone delivery system. The tool controller 1460 than can provide the requirements to the ozone system controller 1406, which then can regulate the power and the oxygen input to achieve the required output ozone flow.

In some embodiments, a processing system comprising an ozone delivery system capable of delivering multiple ozone outputs through a distribution manifold is disclosed. The distribution manifold can be installed in close proximity with a process chamber. The ozone characteristics can thus be monitored, measured or controlled at the point of use, addressing the narrow process windows in advanced applications of both front end of line (FEOL) and back end of line (BEOL), especially in ALD, chemical vapor deposition (CVD) and interface treatment. For example, the process chamber can be configured for application using ozone, such as TEOS/Ozone deposition, or ALD processes. Many ALD systems use ozone as an oxidant for film deposition, such as Al₂O₃, HfO₂, ZrO₂, Ta₂O₅ and TiO₂.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A manifold for distributing an ozone input flow to multiple ozone output flows, the manifold comprising
one or more first flow controllers, wherein the inputs of the one or more first flow controllers are coupled to the ozone input flow;
one or more second flow controllers, wherein the inputs of the one or more second flow controllers are coupled to an oxygen flow;
one or more valves, wherein at least one of the one or more valves is coupled between the output of one of the one or more second flow controllers and the output of one of the one or more first flow controllers;
a process controller, wherein the process controller is operable to configure at least one of the one or more first flow controllers, the one or more second flow controllers, and the one or more valves to achieve ozone concentrations and flow rates for the multiple ozone output flows.

2. A manifold as in claim 1 wherein the number of the first flow controllers is one more than the number of the second flow controllers.

3. A manifold as in claim 1 wherein the valves are configured to couple at least one output of the second flow controller with any one of the outputs of the first flow controllers.

4. A manifold as in claim 1 wherein the valves couple the outputs of the first and second flow controllers in a mutually exclusive manner.

5. A manifold as in claim 1 wherein there are two first flow controllers, one second flow controller and two valves, wherein the two valves couple the outputs of the two first flow controllers to the output of the second flow controller.

6. A manifold as in claim 5 wherein the process controller is configured to toggle the two valves.

7. An ozone delivery system for delivering multiple ozone output flows, the ozone delivery system comprising:
an ozone generator;
at least two first flow controllers, wherein the inputs of the first flow controllers are coupled to an output of the ozone generator;
at least one second flow controller, wherein the input of the second flow controller is coupled to an oxygen flow;
at least two valves, wherein the valves couple the outputs of the first flow controllers to the output of the second flow controller;
a process controller, wherein the process controller is operable to configure at least one of the ozone generator, the first flow controllers, the second flow controller, and the valves to achieve ozone concentrations and flow rates for the multiple ozone output flows.

8. An ozone delivery system as in claim 1 wherein the process controller is configured to toggle the two valves.

9. An ozone delivery system as in claim 1 wherein the ozone generator is configured to deliver the highest ozone concentration among the multiple ozone output flows.

10. An ozone delivery system as in claim 1 wherein the ozone generator is configured to accept an oxygen flow rate, wherein the oxygen flow rate comprises a sum of the ozone output flow having the highest ozone concentration and the remaining ozone output flow weighted by the ratio of the flow concentration and the highest concentration.

11. An ozone delivery system as in claim 1 wherein the number of the first flow controllers is one more than the number of the second flow controllers.

12. An ozone delivery system as in claim 1 wherein the valves are configured to couple at least one output of the second flow controller with any one of the outputs of the first flow controllers.

13. An ozone delivery system as in claim 1 wherein the valves couple the second flow controllers with the first flow controllers in a mutually exclusive manner.

14. A method for distributing an ozone flow to multiple ozone output flows, the method comprising
coupling an output of an ozone generator to a first input of a manifold, wherein the manifold comprises multiple outputs;
coupling an oxygen flow to a second input of the manifold;
setting a power of the ozone generator to generate the highest ozone concentration among the multiple ozone output flows;
setting an input oxygen flow rate for the oxygen flow to achieve flow rates for each of the multiple ozone output flows.

15. A method as in claim 1 wherein the input oxygen flow rate comprises a sum of the ozone output flow having the highest ozone concentration and the remaining ozone output flow weighted by the ratio of the flow concentration and the highest concentration.

16. A method as in claim 14 further comprising
regulating a first output of the ozone generator to generate a first ozone flow rate, wherein the first ozone flow rate is equal to the ozone output flow of the multiple ozone output flows having the highest ozone concentration.

17. A method as in claim 16 further comprising
regulating a second output of the ozone generator to generate a second ozone flow rate, wherein the second ozone flow rate is equal to the first ozone flow rate weighted by the ratio of the concentration of an ozone output flow of the multiple ozone output flows and the highest ozone concentration.

18. A method as in claim 17 further comprising
regulating the oxygen flow to generate a regulated oxygen flow rate, wherein the regulated oxygen flow rate is equal to the difference between the ozone output flow of the multiple ozone output flows and the first ozone flow rate; and
mixing the regulated oxygen flow with the second ozone output flow rate.

19. A method as in claim 14 wherein the manifold comprises
one or more first flow controllers, wherein the inputs of the first flow controllers are coupled to the first inputs of the manifold;
one or more second flow controllers, wherein the inputs of the second flow controllers are coupled to the second input of the manifold;
one or more valves, wherein at least one of the valves is coupled between the output of one of the second flow controllers and the output of one of the first flow controllers.

20. A method as in claim 14 wherein the manifold comprises
one or more first flow controllers, wherein the inputs of the first flow controllers are coupled to the first inputs of the manifold;
one or more second flow controllers, wherein the inputs of the second flow controllers are coupled to the second input of the manifold;
a distribution manifold, wherein the distribution manifold distributes the output of the second flow controllers to the outputs of the first flow controllers.
